(19) United States
(12) Patent Application Publication
(10) Pub. No.: US 2014/0181734 A1
(43) Pub. Date: Jun. 26, 2014

(54) METHOD AND APPARATUS FOR DISPLAYING SCREEN IN ELECTRONIC DEVICE

(71) Applicant: Samsung Electronics Co., Ltd., Suwon-si (KR)

(72) Inventor: Jeong-Gyu JIN, Suwon-si (KR)

(73) Assignee: Samsung Electronics Co., Ltd., Suwon-si (KR)

(21) Appl. No.: 14/079,960

(22) Filed: Nov. 14, 2013

(30) Foreign Application Priority Data
Dec. 24, 2012 (KR) 10-2012-0152398

(51) Int. Cl. G06F 3/0485

(52) U.S. Cl. CPC G06F 3/04855
USPC 715/786

(57) ABSTRACT

A method for displaying a screen of an electronic device is provided. The method includes detecting a first gesture, moving a content according to the first gesture so that part of the content corresponding to a first particular region of the screen is placed at a center of the screen, displaying an aspect ratio scroll in a second particular region of the screen, detecting a second gesture for controlling the aspect ratio scroll, and magnifying or demagnifying the content based on the center of the screen, according to the second gesture.

### CROSS-REFERENCE TO RELATED APPLICATION(S)

This application claims the benefit under 35 U.S.C. §119(a) of a Korean patent application filed on Dec. 24, 2012 in the Korean Intellectual Property Office and assigned Serial No. 10-2012-0152398, the entire disclosure of which is hereby incorporated by reference.

### TECHNICAL FIELD

The present disclosure relates to an electronic device. More particularly, the present disclosure relates to a method and an apparatus for displaying a screen in the electronic device.

### BACKGROUND

Portable terminals according to the related provide various functions for the sake of user's convenience, and are miniaturized and light-weighted. As the portable terminal is developed with a smaller size, mounting the various input keys to the portable terminal becomes difficult. In this respect, methods for easily inputting information to the small-sized portable terminal are researched and introduced. For example, a recent portable terminal includes a touch screen panel as an input means.

The portable terminal including the touch screen panel as the input means is capable of controlling the screen display using the touch screen panel. For example, the touch screen panel is capable of controlling magnifying or demagnifying the screen. For example, a portable terminal according to the related art magnifies and demagnifies the screen using multi-touch.

As an example, the multi-touch recognizes two points touched by two fingers of the user and magnifies or demagnifies the screen according to a distance change of the two touch points in the portable terminal For example, when the distance between the two touch points shrinks, the screen is demagnified. When the distance between the two touch points grows, the screen is magnified.

According to the related art, a double-tap or a multi-tap may be used to magnify/demagnify the screen. For example, the double-tap magnifies the screen and one more double-tap demagnifies the screen.

However, the multi-touch magnifies and demagnifies the screen according to the distance change between the two fingers touching the screen. Accordingly, to magnify or demagnify the screen up to an intended level, the user needs to repeatedly touch the screen with the finger and remove the finger so as to magnify or demagnify the screen.

While the multi-tap can easily magnify the screen based on a multi-touch point, the multi-touch is required to magnify the screen again after the multi-tap.

Thus, a need exists for a method and an apparatus for easily magnifying and demagnifying the screen after the multi-tap.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide a method and an apparatus for displaying a screen in an electronic device.

Another aspect of the present disclosure is to provide a method and an apparatus for magnifying and demagnifying a screen according to scrolling after multi-tap in a portable terminal

Another aspect of the present disclosure is to provide a method and an apparatus for precisely magnifying and demagnifying a user's intended region through scrolling after multi-tap.

In accordance with an aspect of the present disclosure, a method for displaying a screen of an electronic device is provided. The method includes detecting a first gesture, moving a content according to the first gesture so that part of the content corresponding to a first particular region of the screen is placed at a center of the screen, displaying an aspect ratio scroll in a second particular region of the screen, detecting a second gesture for controlling the aspect ratio scroll, and magnifying or demagnifying the content based on the center of the screen, according to the second gesture.

In accordance with another aspect of the present disclosure, an electronic device is provided. The electronic device includes at least one processor, a memory, and at least one program stored to the memory and configured to be executed by the at least one processor. The at least one program includes instructions for detecting a first gesture, for moving a content according to the first gesture so that part of the content corresponding to a first particular region of the screen is placed at a center of the screen, for displaying an aspect ratio scroll in a second particular region of the screen, for detecting a second gesture for controlling the aspect ratio scroll, and for magnifying or demagnifying the content based on the center of the screen, according to the second gesture.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIGS. 1A and 1B are diagrams of scenarios for controlling screen display according to an embodiment of the present disclosure;

FIGS. 2A, 2B, 2C, and 2D are diagrams of scenarios for controlling a screen display according to an embodiment of the present disclosure;

FIGS. 3A, 3B and 3C are diagrams of scenarios for controlling a screen display according to an embodiment of the present disclosure;

FIG. 4 is a flowchart of a screen control method according to an embodiment of the present disclosure; and

FIG. 5 is a block diagram of an electronic device according to an embodiment of the present disclosure.

Throughout the drawings, like reference numerals will be understood to refer to like parts, components and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

Various embodiments of the present disclosure provide a method and an apparatus for displaying a screen in an electronic device.

As a non-exhaustive illustration only, an electronic device described herein may refer to mobile devices such as a cellular phone, a Personal Digital Assistant (PDA), a digital camera, a portable game console, an MP3 player, a Portable/Personal Multimedia Player (PMP), a handheld e-book, a tablet PC, a portable lap-top PC, a Global Positioning System (GPS) navigation, and devices such as a desktop PC, a high definition television (HDTV), an optical disc player, a set-top box, and the like capable of wireless communication or network communication consistent with that disclosed herein.

Hereinafter, the term “touch” indicates that a user's finger or a stylus pen contacts a touch screen. The term “touch release” indicates that the finger or the stylus pen detaches from the touch screen. Double-tap (or multi-tap) applies and releases a first touch on the touch screen, and immediately applies and releases a second touch. The term “drag” indicates that the touch is held on the touch screen and the touch point is moved. The term “drag release” indicates that the user drags and detaches the finger or the stylus pen on the touch screen.

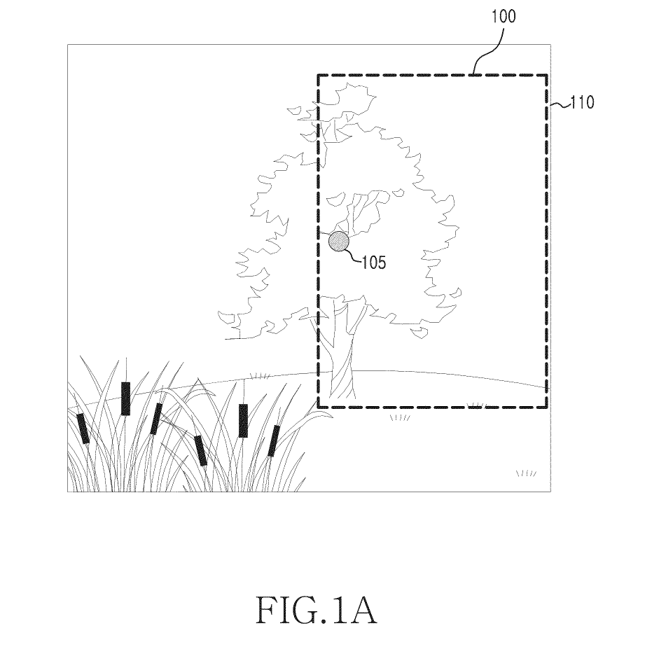

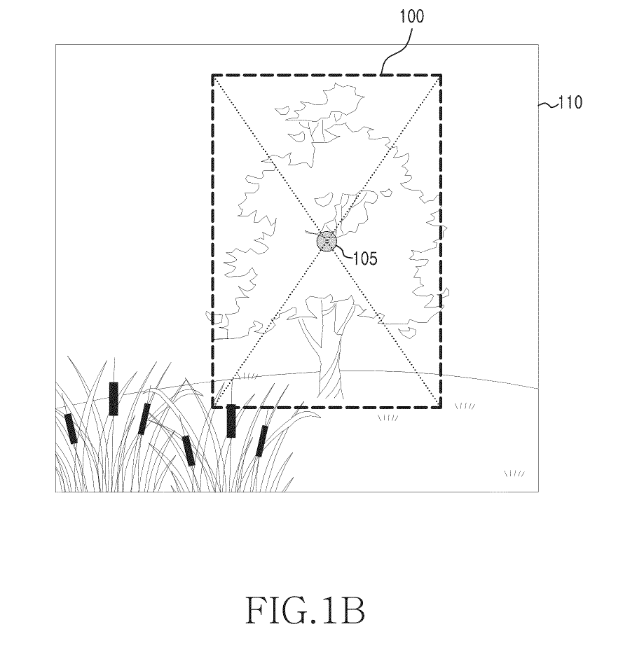

FIGS. 1A and 1B are diagrams of scenarios for controlling screen display according to an embodiment of the present disclosure.

Referring to FIG. 1A, an initial screen before a single touch or the double-tap (or the multi-tap) is detected on the touch screen of the electronic device is illustrated. The initial screen can display a webpage or an image, and the webpage or the image is greater than the screen in size such that the actual screen 100 displays part of the webpage or image 110. According to various embodiments of the present disclosure, the screen can display the entire webpage or image 110 in proportion to the screen size.

Next, when the double-tap or the multi-tap is detected at a particular point 105 of the initial screen, the screen 100 displays the image or webpage 110 by moving an image region or a webpage content corresponding to the particular point 105 to the center of the screen as shown in FIG. 1B. The particular point corresponds to part of the user's intended image or webpage, and is a first touch point or a second touch point of the double-tap. According to various embodiments of the present disclosure, the first touch point and the second touch point are substantially the same.

Referring to FIG. 1B, the screen after the double-tap (or the multi-tap) is detected on the touch screen of the electronic device is illustrated.

For example, when the double-tap or the multi-tap is detected at the particular point 105 on the initial screen of FIG. 1A, the image region or the webpage content corresponding to the particular point 105 is moved to the center of the screen. In so doing, the screen displays a reference point of various shapes (e.g., circle or quadrangle) indicative of the screen center, and separate information (e.g., two dotted diagonals) for identifying the reference point. The information for identifying the reference point may be displayed transparently or translucently.

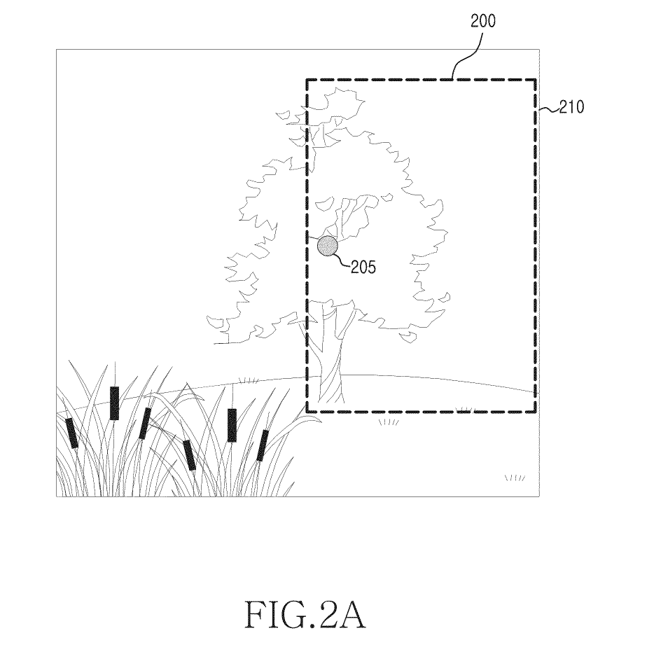

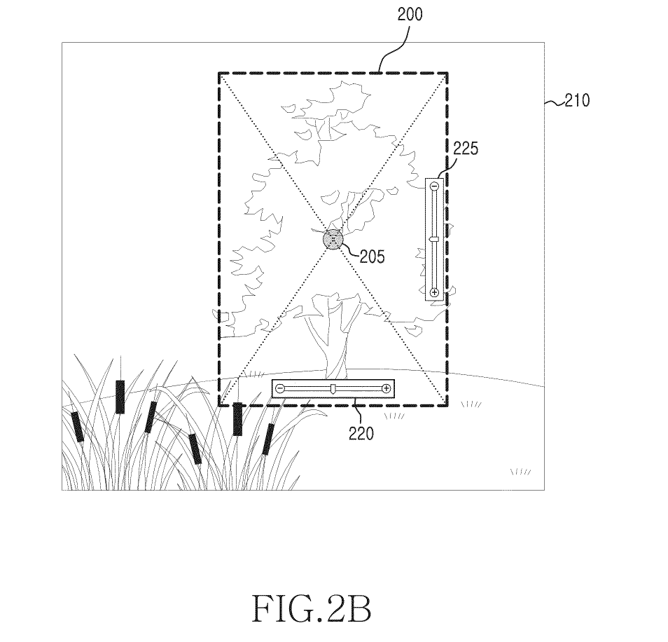

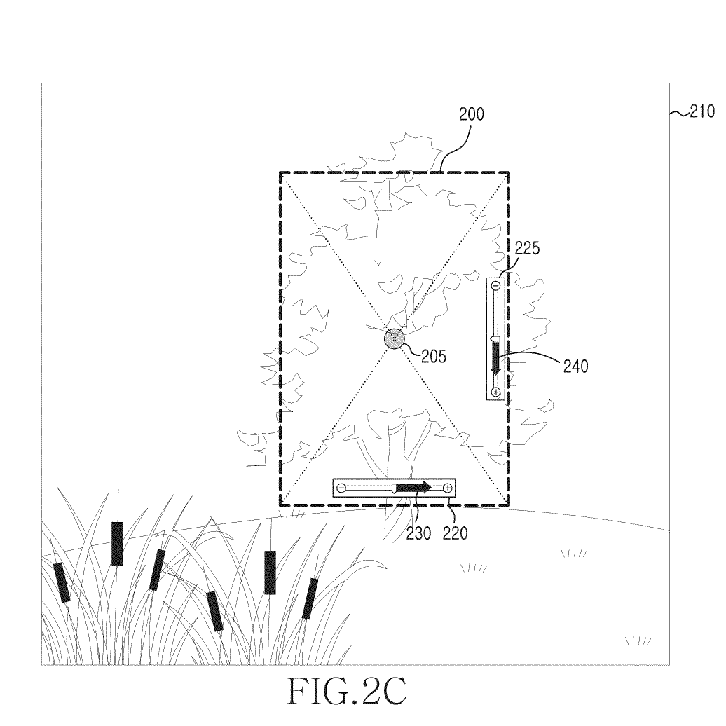

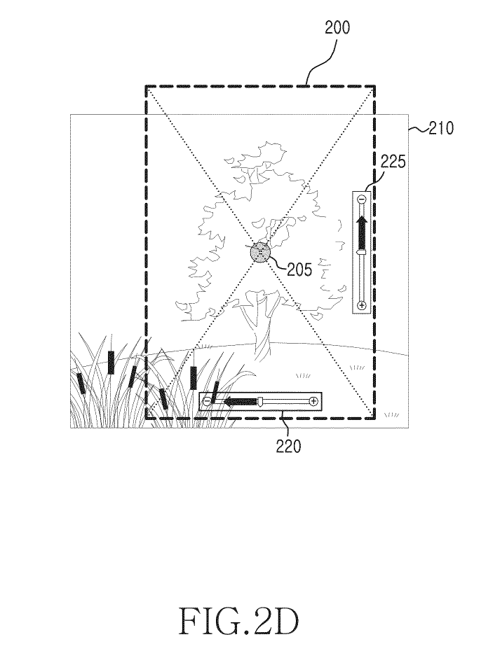

FIGS. 2A, 2B, 2C, and 2D are diagrams of scenarios for controlling a screen display according to an embodiment of the present disclosure.

Referring to FIG. 2A, the double-tap (or the multi-tap) on a particular point 205 on a screen 200 of the electronic device is depicted. The screen 200 can display a webpage or image 210, and the webpage or the image is greater than the screen in size such that the actual screen 200 displays part of the webpage or image 210. According to various embodiments of the present disclosure, the screen 200 can display the entire webpage or image 210 in proportion to the screen size.

Referring to FIG. 2B, a screen after the double-tap (or the multi-tap) is detected on the touch screen of the electronic device is illustrated. For example, when the double-tap or the multi-tap is detected at the particular point 205 on the screen of FIG. 2A, the image region or the webpage content corresponding to the particular point 205 is moved to the center of the screen 200. In so doing, the screen displays the reference point of various shapes (e.g., circle or quadrangle) indicative of the screen center, and the separate information (e.g., two dotted diagonals) for identifying the reference point. The information may be displayed transparently or translucently.

According to various embodiments of the present disclosure, a scroll region 220 and a scroll bar 225 for adjusting an aspect ratio may be displayed in relation to the screen 200. For example, a scroll region 220 and a scroll bar 225 for adjusting an aspect ratio may be displayed at the center of the bottom or at the center of the right side. The scroll region 220 may include a scroll region indicator and the scroll bar 225 may include a scroll bar indicator, each of which may be moved to adjust the aspect ratio. The positions of the scroll region 220 and the scroll bar 225 are not limited to the center of the bottom or the center of the right side, and can be displayed in other particular regions of the screen 200. According to various embodiments of the present disclosure, the scroll bar can be disposed at the center of the scroll region. Alternatively, after the image region or the webpage content corresponding to the particular point 205 is moved to the center of the screen, when the current screen is not further demagnified, the initial scroll bar can be disposed at the end of the left side.

Referring to FIG. 2C, the double-tap (or the multi-tap) is detected on the touch screen of the electronic device, the image region or the webpage content corresponding to the particular point is moved to the center of the screen 220, and a scroll region 220 and a scroll bar 225 for adjusting the aspect ratio are moved in a first direction. The scroll region 220 may include a scroll region indicator and the scroll bar 225 may include a scroll bar indicator, each of which may be moved to adjust the aspect ratio. Thus, the webpage or the image 210 is magnified.

For example, when the scroll region indicator at the center of the scroll region 220 is moved to the right as indicated by reference numeral 230, or the scroll bar indicator at the center of the scroll bar 225 is moved downward as indicated by reference numeral 240, the webpage or the image is magnified based on the center of the screen.

Referring to FIG. 2D, the double-tap (or the multi-tap) is detected on the touch screen of the electronic device, the image region or the webpage content corresponding to the particular point 205 is moved to the center of the screen 200, and the scroll region 220 and the scroll bar 225 for adjusting the aspect ratio are moved in a second direction. Thus, the webpage or the image is demagnified.

For example, when the scroll region indicator at the center of the scroll region 220 is moved to the left, or the scroll bar indicator at the center of the scroll bar 225 is moved upward, the webpage or the image 210 is demagnified based on the center of the screen.

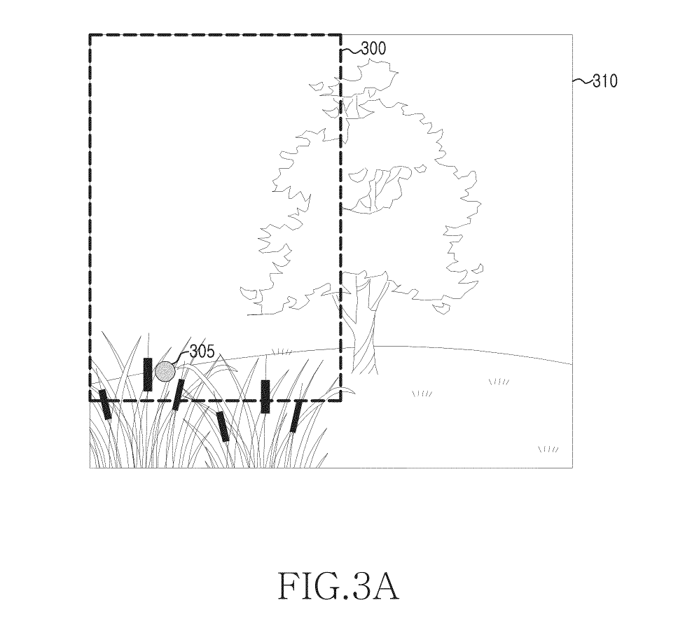

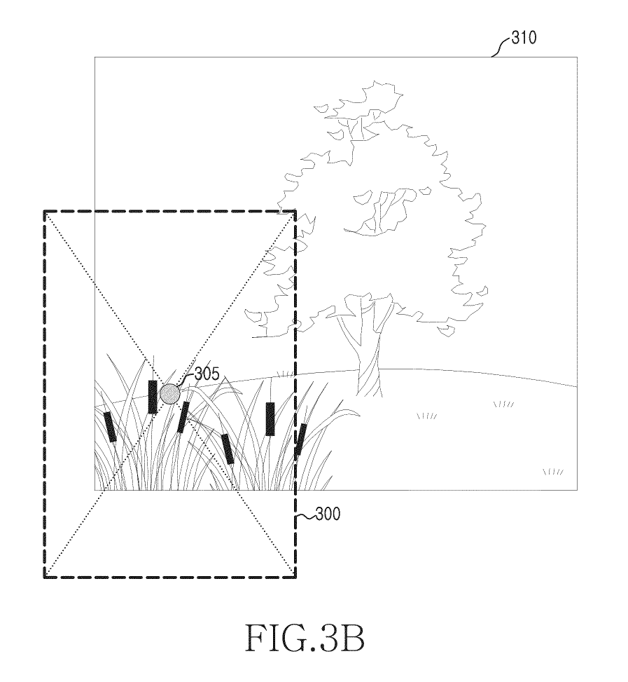

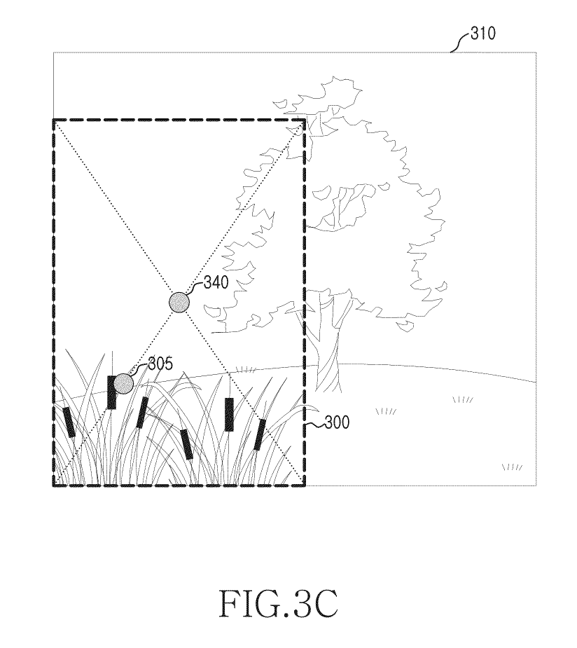

FIGS. 3A, 3B and 3C are diagrams of scenarios for controlling a screen display according to an embodiment of the present disclosure.

Referring to FIG. 3A, an initial screen before the single touch or the double-tap (or the multi-tap) is detected on the touch screen of the electronic device is illustrated. According to various embodiments of the present disclosure, the initial screen can display a webpage or an image, and the webpage or the image is greater than the screen in size such that the actual screen 300 displays part of the webpage or image 310. According to various embodiments of the present disclosure, the screen can display the entire webpage or image 310 in proportion to the screen size.

Next, when the double-tap or the multi-tap is detected at a particular point 305 of the initial screen, the screen 300 displays the image or webpage 310 by moving an image region or a webpage content corresponding to the particular point 305 to the center of the screen as shown in FIG. 3B. The particular point 305 corresponds to part of the user's intended image or webpage. As an example, the particular point 305 is assumed to be a left lower portion of the webpage or image 310.

Referring to FIG. 3B, the screen after the double-tap (or the multi-tap) is detected on the touch screen of the electronic device is illustrated.

For example, when the double-tap or the multi-tap is detected at the particular point 305 on the initial screen of FIG. 3A, the image region or the webpage content corresponding to the particular point 305 is moved to the center of the screen 300. The particular point corresponds to the left lower portion of the webpage or image 310. Hence, when the image region or webpage content corresponding to the particular point 305 is moved to the center of the screen, margins are generated in the left portion and the lower portion of the screen 300. The screen 300 displays the reference point of various shapes (e.g., circle or quadrangle) indicative of the screen center, and the separate information (e.g., two dotted diagonals) for identifying the reference point. The information may be displayed transparently or translucently.

Alternatively, to prevent the margin on the screen, the image region or webpage content corresponding to the particular point 305 may not be moved to the very center of the screen as shown in FIG. 3C.

Referring to FIG. 3C, no margin on the screen after the double-tap (or the multi-tap) is detected on the touch screen of the electronic device is illustrated.

For example, when the double-tap or the multi-tap is detected at the particular point 305 on the initial screen of FIG. 3A, the image region or the webpage content corresponding to the particular point 305 is moved to the center of the screen 300. When the image region or the webpage content corresponding to the particular point is moved to the center of the screen and margins are generated in part of the screen, the image region or the webpage content corresponding to the particular point 305 is moved close to the center of the screen, rather than the very center of the screen, so as not to generate the margins on the screen 300. For example, when the center 340 of the screen matches the particular point 305, the margins are generated on the screen. Hence, the particular point 305 is moved close to the center 340 of the screen so as to minimize the margins on the screen. Meanwhile, the screen displays the separate information (e.g., two dotted diagonals) for identifying the reference point of various shapes (e.g., circle or quadrangle) indicative of the center 340 of the screen. The information may be displayed transparently or translucently.

Although FIGS. 1A, 1B, 2A, 2B, 2C, 2D, 3A, 3B, and 3C illustrate examples in which the screen displays the webpage or the image, various embodiments of the present disclosure are applicable to various documents such as a document stored in a memory, a webpage document received wired or wirelessly, a still image or video captured using a camera, a memo, incoming/outgoing e-mails, and/or the like.

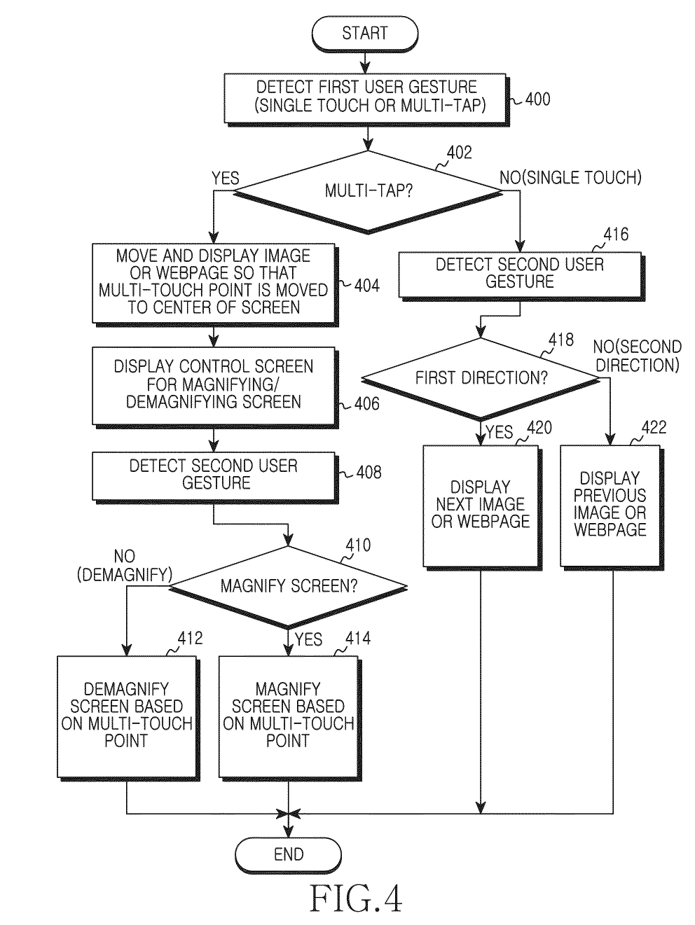

FIG. 4 is a flowchart of a screen control method according to an embodiment of the present disclosure.

Referring to FIG. 4, at operation 400, the electronic device detects a first user gesture. For example, the electronic device detects the single touch or the double-tap (or the multi-tap).

At operation 402, the electronic device determines whether the detected first user gesture corresponds to a multi-tap. For example, at operation 402, the electronic device determines whether the detected first user gesture corresponds to a single touch or a multi-tap.

If the electronic device determines that the first user gesture is the single touch operation at 402, then the electronic device proceeds to operation 416 at which the electronic device detects a second user gesture. For example, the second user gesture is the drag of a first direction (e.g., the gesture for turning the page to the left) or the drag of a second direction (e.g., the gesture for turning the page to the right).

At operation 418, the electronic device determines whether the second user gesture is a drag in the first direction. For example, the electronic device determines whether the second user gesture corresponds to a drag in the first direction or a drag in the second direction.

If the electronic device determines that the second user gesture is the drag of the first direction (e.g., the gesture for turning the page to the left) at operation 418, then the electronic device proceeds to operation 420 at which the electronic device displays a next image or a next webpage.

In contrast, if the electronic device determines that the second user gesture is the drag of the second direction (e.g., the gesture for turning the page to the right) at operation 418, then the electronic device proceeds to operation 422 at which the electronic device displays a previous image or a previous webpage in.

In contrast, if the electronic device determines that first user gesture is the double-tap (the multi-tap) at operation 402, then the electronic device proceeds to operation 404 at which the electronic device determines the first or second touch point of the double-tap and moves the webpage or the image so that the corresponding webpage content or image region is displayed at the center of the screen.

Although it is not illustrated in FIG. 4, when the first or second touch point of the double-tap is at the end of the left, right, top, or bottom side of the webpage or image, as described in relation to FIG. 3C, the electronic device may move the webpage or image as close as possible to the center of the screen so as to not to display the margin on the screen.

When the webpage content or image region corresponding to the first or second touch point of the double-tap is displayed at the center of the screen, the electronic device displays a pointer indicating the center, or the separate information (e.g., two dotted diagonals) for identifying the reference point such as circle or quadrangle. The pointer indicating the center or the separate information for identifying the reference point such as circle or quadrangle may be displayed transparently or translucently.

At operation 406, the electronic device displays an aspect ratio control screen (e.g., the scroll region and the scroll bar for adjusting the aspect ratio) in a particular region of the screen. The particular region can occupy the bottom side or the right side of the screen. Likewise, a scroll control screen for magnifying and demagnifying the screen, which is provided for the convenience, can be displayed transparently or translucently.

At operation 408, the electronic device detects the second user gesture for magnifying or demagnifying the screen. For example, the second user gesture for magnifying the screen moves the scroll bar, at the center of the scroll region, to the right or downward, and the second user gesture for demagnifying the screen moves the scroll bar, at the center of the scroll region, to the left or upward.

At operation 410, the electronic device determines whether the second user gesture corresponds to a gesture for magnifying the screen. For example, at operation 410, the electronic device determines whether the second user gesture corresponds to a gesture for magnifying the screen or whether the second user gesture corresponds to a gesture for demagnifying the screen.

If the electronic device determines that the second user gesture demagnifies the screen at operation 410, then the electronic device proceeds to operation 412 at which the electronic device demagnifies the screen based on the reference point in proportion to the moving distance of the scroll bar.

In contrast, if the electronic device determines that the second user gesture magnifies the screen at operation 410, then the electronic device proceeds to operation 414 at which the electronic device magnifies the screen based on the reference point in proportion to the moving distance of the scroll bar.

Next, the electronic device finishes this process.

As such, the screen is magnified or demagnified according to the user's scrolling, in proportion to the moving distance of the scroll bar based on the reference point according to the correlation between the reference point and the center of the screen. When the reference point defined by the double-tap is at the center of the screen, the screen is magnified or demagnified based on the center of the screen. When the reference point defined by the double-tap is not at the center of the screen and the scroll bar magnifies the screen, the reference point is moved toward the center together with the magnification.

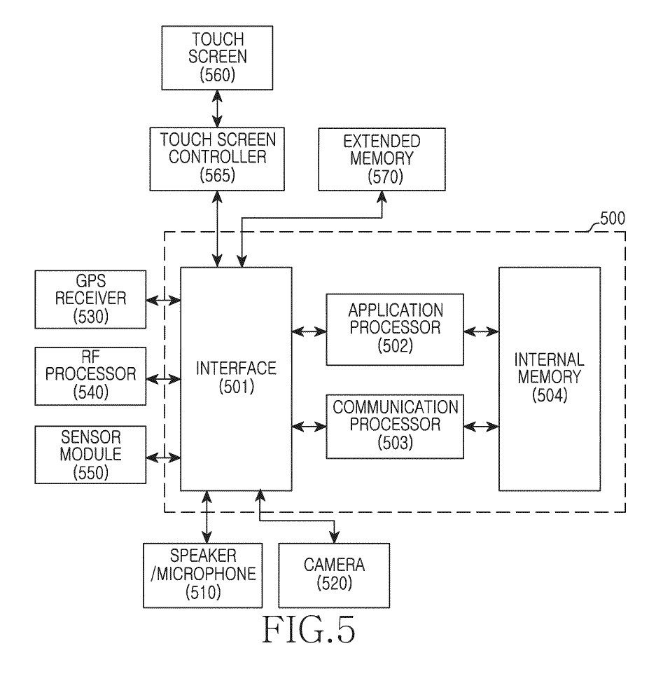

FIG. 5 is a block diagram of an electronic device according to an embodiment of the present disclosure.

Referring to FIG. 5, the electronic device includes a controller 500, a speaker/microphone 510, a camera 520, a Global Positioning System (GPS) receiver 530, a Radio Frequency (RF) processor 540, a sensor module 550, a touch screen 560, a touch screen controller 565, and an extended memory 570.

The controller 500 can include an interface 501, one or more processors such as an application processor 502 and a communication processor 503, and an internal memory 504. In some cases, the whole controller 500 may be referred to as the processor. The interface 501, the application processor 502, the communication processor 503, and the internal memory 504 can be separate components or integrated onto one or more integrated circuits.

The application processor 502 performs various functions for the electronic device by running various software programs, and the communication processor 503 processes and controls voice communication and data communication. In addition to those typical functions, the processors 502 and 503 also execute a particular software module (instruction set) stored in the extended memory 570 or the internal memory 504 and conduct particular functions corresponding to the module. For example, the processors 502 and 503 carry out the screen display control method of the present disclosure in association with software modules stored in the extended memory 570 or the internal memory 504.

For example, the application processor 502 detects the first user gesture, detects whether the first user gesture is the single touch or the double-tap (or the multi-tap), detects the second gestures. For example, the application processor 502 detects whether the second user gesture is the drag of the first direction (e.g., the gesture for turning the page to the left) or the drag of the second direction (e.g., the gesture for turning the page to the right) when the first user gesture is the single touch. The application processor 502 may also display the next image or the next webpage when the second user gesture is the drag of the first direction (e.g., the gesture for turning the page to the left), and display the previous image or the previous webpage when the second user gesture is the drag of the second direction (e.g., the gesture for turning the page to the right).

When the first user gesture is the double-tap (or the multi-tap), the application processor 502 determines the first or second touch point of the double-tap and moves the webpage or the image so that the corresponding webpage content or image region is displayed at the center of the screen. When the first or second touch point of the double-tap is at the end of the left, right, top, or bottom side of the webpage or image, the application processor 502 moves the webpage or image as close as possible to the center of the screen so as to not to display the margin on the screen, as discussed in relation to FIG. 3C.

When the webpage content or image region corresponding to the first or second touch point of the double-tap is displayed at the center of the screen, the application processor 502 displays the pointer indicating the center or the separate information (e.g., two dotted diagonals) for identifying the reference point such as circle or quadrangle, and displays the aspect ratio control screen (e.g., the scroll region and the scroll bar for adjusting the aspect ratio) in the particular portion of the screen. Advantageously, the particular portion can occupy the bottom side or the right side of the screen. The application processor 502 detects the second user gesture for magnifying or demagnifying the screen. For example, the second user gesture for magnifying the screen moves the scroll bar, at the center of the scroll region, to the right or downward, and the second user gesture for demagnifying the screen moves the scroll bar, at the center of the scroll region, to the left or upward. When the second user gesture demagnifies the screen, the application processor 502 demagnifies the screen based on the reference point in proportion to the moving distance of the scroll bar. When the second user gesture magnifies the screen, the application processor 502 magnifies the screen based on the reference point in proportion to the moving distance of the scroll bar.

Another processor (not shown) can include one or more data processors, an image processor, or a CODEC. The data processors, the image processor, or the CODEC may be separately equipped or include a plurality of processors for different functions. The interface 501 interconnects the touch screen controller 565 and the extended memory 570 of the electronic device.

The sensor module 550 is coupled to the interface 501 to allow various functions. For example, a motion sensor and an optical sensor can be coupled to the interface 501 to detect a motion of the electronic device or to detect the light from the outside. According to various embodiments of the present disclosure, other sensors such as position determining system, temperature sensor, biometric sensor, and/or the like can be connected to the interface 501 to perform related functions.

The camera 520 is coupled to the sensor module 550 through the interface 501 to perform a camera function such as photo and video clip recording.

The RF processor 540 performs a communication function. For example, under control of the communication processor 503, the RF processor 540 converts an RF signal to a baseband signal and provides the baseband signal to the communication processor 503, or converts a baseband signal output from the communication processor 503 to an RF signal and transmits the RF signal. According to various embodiments of the present disclosure, the communication processor 503 processes the baseband signal according to various communication schemes. For example, the communication scheme can include, but not limited to, a Global System for Mobile communication (GSM) communication scheme, an Enhanced Data GSM Environment (EDGE) communication scheme, a Code Division Multiple Access (CDMA) communication scheme, a W-CDMA communication scheme, a Long Term Evolution (LTE) communication scheme, an Orthogonal Frequency Division Multiple Access (OFDMA) communication scheme, a Wireless Fidelity (Wi-Fi) communication scheme, a WiMax communication scheme, and/or a Bluetooth communication scheme.

The speaker/microphone 510 can input and output an audio signal for voice recognition, voice reproduction, digital recording, and telephone function. For example, the speaker/microphone 510 converts the voice signal to an electric signal or converts the electric signal to the voice signal. An attachable and detachable earphone, headphone, or headset (not shown) can be connected to the electronic device through an external port.

The touch screen controller 565 can be coupled to the touch screen 560. The touch screen 560 and the touch screen controller 565 can detect the touch and the motion thereof or the stopping of the motion of the touch or the release of the touch using, but not limited to, capacitive, resistive, infrared, surface sound wave techniques, and/or the like for determining one or more touch points with the touch screen 560 and a multitouch detection technique including various proximity sensor arrays or other elements.

The touch screen 560 provides an input/output interface between the electronic device and the user. For example, the touch screen 560 forwards a user's touch input to the electronic device. The touch screen 560 also presents the output of the electronic device to the user. For example, the touch screen 560 presents a visual output to the user. The visual output can be represented as text, graphic, video, or the like, and any combination thereof.

The touch screen 560 can employ various displays, examples of which include, but are not limited to, Liquid Crystal Display (LCD), Light Emitting Diode (LED), Light emitting Polymer Display (LPD), Organic LED (OLED), Active Matrix OLED (AMOLED), Flexible LED (FLED), or the like.

The GPS receiver 530 converts a signal received from an artificial satellite, to information such as location, speed, or time. For example, a distance between the satellite and the GPS receiver 530 can by calculated by multiplying the speed of light by a signal arrival time. The location of the electronic device may be measured using the well-known triangulation by obtaining accurate positions and distances of three satellites.

The extended memory 570 or the internal memory 504 can include fast random access memory such as one or more magnetic disc storage devices and/or non-volatile memory, one or more optical storage devices, and/or a flash memory (e.g., NAND and NOR).

The extended memory 570 or the internal memory 504 stores software. Software components include an operating system software module, a communication software module, a graphic software module, a user interface software module, an MPEG module, a camera software module, one or more application software modules, and/or the like. Because the module being the software component can be a set of instructions, the module can be referred to as an instruction set. The module may be referred to as a program.

The operating system software includes various software components for controlling general system operations. As an example, the control of the general system operations includes memory management and control, storage hardware (device) control and management, and power control and management. The operating system software may process normal communication between various hardware devices and the software components (modules).

The communication software module allows communication with other electronic devices such as computer, server, and/or portable terminal, through the RF processor 540. The communication software module is configured in a protocol architecture of the corresponding communication scheme.

The graphic software module includes various software components for providing and displaying graphics on the touch screen 560. The term ‘graphics’ embraces text, webpage, icon, digital image, video, animation, and/or the like.

The user interface software module includes various software components relating to a user interface. The user interface software module is involved in the status change of the user interface and the condition of the user interface status change.

The camera software module includes camera related software components allowing camera related processes and functions.

The application module includes a browser, an e-mail, an instant message, a word processing, keyboard emulation, an address book, a touch list, a widget, Digital Right Management (DRM), voice recognition, voice reproduction, a position determining function, a location based service, and the like.

The memories 570 and 504 can include an additional module (instructions) in addition to the above-stated modules. Alternatively, if necessary, some of the modules (instructions) may not be used.

The application module includes instructions for controlling the screen display such as the controlling of the screen display described in relation to FIG. 4.

For example, the application module detects the first user gesture, detects whether the first user gesture is the single touch or the double-tap (or the multi-tap), detects the second gestures. The application module may detect whether the second user gesture is the drag of the first direction (e.g., the gesture for turning the page to the left) or the drag of the second direction (e.g., the gesture for turning the page to the right) when the first user gesture is the single touch. The application module may display the next image or the next webpage when the second user gesture is the drag of the first direction (e.g., the gesture for turning the page to the left), and display the previous image or the previous webpage when the second user gesture is the drag of the second direction (e.g., the gesture for turning the page to the right).

When the first user gesture is the double-tap (or the multi-tap), the application module determines the first or second touch point of the double-tap and moves the webpage or the image so that the corresponding webpage content or image region is displayed at the center of the screen. When the first or second touch point of the double-tap is at the end of the left, right, top, or bottom side of the webpage or image, the application module moves the webpage or image as close as possible to the center of the screen so as to not to display the margin on the screen as described in relation to FIG. 3C.

When the webpage content or image region corresponding to the first or second touch point of the double-tap is displayed at the center of the screen, the application module displays the pointer indicating the center or the separate information (e.g., two dotted diagonals) for identifying the reference point such as circle or quadrangle, and displays the aspect ratio control screen (e.g., the scroll region and the scroll bar for adjusting the aspect ratio) in the particular portion of the screen. According to various embodiments of the present disclosure, the particular portion can occupy the bottom side or the right side of the screen. The application module detects the second user gesture for magnifying or demagnifying the screen. For example, the second user gesture for magnifying the screen moves the scroll bar, at the center of the scroll region, to the right or downward, and the second user gesture for demagnifying the screen moves the scroll bar, at the center of the scroll region, to the left or upward. When the second user gesture demagnifies the screen, the application module demagnifies the screen based on the reference point in proportion to the moving distance of the scroll bar. When the second user gesture magnifies the screen, the application module magnifies the screen based on the reference point in proportion to the moving distance of the scroll bar.

The methods described in the claims and/or the specification of the present disclosure can be implemented using hardware and software alone or in combination.

According to various embodiments of the present disclosure, a non-transitory computer-readable storage medium including one or more programs (software modules) can be provided. One or more programs stored to the non-transitory computer-readable storage medium are configured for execution of one or more processors of the electronic device. One or more programs include instructions making the electronic device execute the methods according to the various embodiments as described in the claims and/or the specification of the present disclosure.

The program (software module, software) can be stored to a random access memory, a non-volatile memory including a flash memory, a Read Only Memory (ROM), an Electrically Erasable Programmable ROM (EEPROM), a magnetic disc storage device, a Compact Disc (CD)-ROM, Digital Versatile Discs (DVDs) or other optical storage devices, and a magnetic cassette. Alternatively, the program can be stored to a memory combining part or all of those recording media. A plurality of memories may be equipped.

The program can be stored to an attachable storage device of the electronic device accessible via the communication network such as Internet, Intranet, LAN, WLAN, or SAN, or a communication network combining the networks. The storage device can access the electronic device through an external port.

A separate storage device in the communication network can access the portable electronic device.

As set forth above, the user can move the user's intended region to the center of the screen using the gesture such as multi-tap or double-tap and then scroll through the screen based on the center. Therefore, the screen can be magnified or demagnified precisely.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A method in an electronic device, the method comprising:
detecting a first gesture;
moving a content according to the first gesture so that part of the content corresponding to a first particular region of the screen is placed at a center of the screen;
displaying an aspect ratio scroll in a second particular region of the screen;
detecting a second gesture for controlling the aspect ratio scroll; and
magnifying or demagnifying the content based on the center of the screen, according to the second gesture.

2. The method of claim 1, wherein the first gesture corresponds to a multi-tap, and
wherein the second gesture corresponds to scrolling.

3. The method of claim 1, further comprising:
determining a region of the content corresponding to a touch point of the first gesture.

4. The method of claim 1, wherein the aspect ratio scroll comprises at least one of a scroll region and a scroll bar,
wherein the scroll region is placed horizontally at a bottom of the screen, and
wherein a first scroll indicator is initially placed at one of a center of the scroll region and an end of a left side of the scroll region.

5. The method of claim 4, wherein, after the part of the content corresponding to the first particular region of the screen is moved to the center of the screen according to the first gesture, when the screen is magnified or demagnified, the first scroll indicator is initially placed at the center of the scroll region, and
after the part of the content corresponding to the first particular region of the screen is moved to the center of the screen according to the first gesture, when the screen is not magnified or demagnified, the first scroll indicator is initially placed at the end of the left side of the scroll region.

6. The method of claim 1, wherein the aspect ratio scroll comprises at least one of a scroll region and a scroll bar,
wherein the scroll bar is placed vertically in a right side of the screen, and
wherein a second scroll indicator is initially placed at one of a center of the scroll bar and a top of the scroll bar.

7. The method of claim 6, wherein, after the part of the content corresponding to the first particular region of the screen is moved to the center of the screen according to the first gesture, when the screen is magnified or demagnified, the second scroll indicator is initially placed at the center of the scroll bar, and
after the part of the content corresponding to the first particular region of the screen is moved to the center of the screen according to the first gesture, when the screen is not magnified or demagnified, the second scroll indicator is initially placed at the top of the scroll bar.

8. The method of claim 1, wherein the magnifying or demagnifying of the content based on the center of the screen according to the second gesture, comprises:
when at least one scroll indicator of the aspect ratio scroll is dragged in a first direction, magnifying the content based on the center of the screen; and
when the at least one scroll indicator of the aspect ratio scroll is dragged in a second direction, demagnifying the content based on the center of the screen.

9. The method of claim 8, wherein the first direction is one of a right direction or a downward direction, and
wherein the second direction is one of a left direction or an upward direction.

10. The method of claim 1, wherein, when the part of the content corresponding to the first particular region of the screen is moved to the center of the screen according to the first gesture and a margin is generated in part of the screen, the part of the content corresponding to the first particular region of the screen is moved toward the center of the screen so as not to generate the margin in part of the screen.

11. An electronic device comprising:
at least one processor;
a memory; and
at least one program stored to the memory and configured to be executed by the at least one processor,
wherein the at least one program comprises instructions for detecting a first gesture, for moving a content according to the first gesture so that part of the content corresponding to a first particular region of the screen is placed at a center of the screen, for displaying an aspect ratio scroll in a second particular region of the screen, for detecting a second gesture for controlling the aspect ratio scroll, and for magnifying or demagnifying the content based on the center of the screen, according to the second gesture.

12. The electronic device of claim 11, wherein the first gesture corresponds to a multi-tap, and
wherein the second gesture corresponds to scrolling.

13. The electronic device of claim 11, wherein the program further comprises:
an instruction for determining a region of the content corresponding to a touch point of the first gesture.

14. The electronic device of claim 11, wherein the aspect ratio scroll comprises at least one of a scroll region and a scroll bar,
wherein the scroll region is placed horizontally at a bottom of the screen, and
wherein a first scroll indicator is initially placed at one of a center of the scroll region and an end of a left side of the scroll region.

15. The electronic device of claim 14, wherein, after the part of the content corresponding to the first particular region of the screen is moved to the center of the screen according to the first gesture, when the screen is magnified or demagnified, the first scroll indicator is initially placed at the center of the scroll region, and
after the part of the content corresponding to the first particular region of the screen is moved to the center of the screen according to the first gesture, when the screen is not magnified or demagnified, the first scroll indicator is initially placed at the end of the left side of the scroll region.

16. The electronic device of claim 11, wherein the aspect ratio scroll comprises at least one of a scroll region and a scroll bar,
wherein the scroll bar is placed vertically in a right side of the screen, and
wherein a scroll indicator is initially placed at one of a center of the scroll bar and a top of the scroll region.

17. The electronic device of claim 16, wherein, after the part of the content corresponding to the first particular region of the screen is moved to the center of the screen according to the first gesture, when the screen is magnified or demagnified, the second scroll indicator is initially placed at the center of the scroll bar, and
after the part of the content corresponding to the first particular region of the screen is moved to the center of the screen according to the first gesture, when the screen is not magnified or demagnified, the second scroll indicator is initially placed at the top of the scroll bar.

18. The electronic device of claim 11, wherein, when at least one a scroll indicator of the aspect ratio scroll is dragged in a first direction, the program magnifies the content based on the center of the screen, and
when the at least one scroll indicator of the aspect ratio scroll is dragged in a second direction, the program demagnifies the content based on the center of the screen.

19. The electronic device of claim 18, wherein the first direction is one of a right direction or a downward direction, and
wherein the second direction is one of a left direction or an upward direction.

20. The electronic device of claim 11, wherein, when the part of the content corresponding to the first particular region of the screen is moved to the center of the screen according to the first gesture and a margin is generated in part of the screen, the part of the content corresponding to the first particular region of the screen is moved toward the center of the screen so as not to generate the margin in part of the screen.

21. A non-transitory computer-readable storage medium storing instructions that, when executed, cause at least one processor to perform the method of claim 1.
